(19) United States
(12) Patent Application Publication
(10) Pub. No.: US 2023/0145082 A1
(43) Pub. Date: May 11, 2023

(54) SYSTEM AND METHOD FOR AUTOMATED EXTRINSIC CALIBRATION OF LIDARS, CAMERAS, RADARS AND ULTRASONIC SENSORS ON VEHICLES AND ROBOTS

(71) Applicant: Kinetic Automation Inc., Mountain View, CA (US)

(72) Inventors: Nikhil Naikal, San Diego, CA (US); Alexander Marques, Frederick, MD (US); Srikanth Malla, San Jose, CA (US)

(21) Appl. No.: 17/981,958

(22) Filed: Nov. 7, 2022

Related U.S. Application Data
(60) Provisional application No. 63/276,823, filed on Nov. 8, 2021.

(51) Int. Cl. G01S 7/497; G01S 17/89; G01S 17/931; G05B 13/02

(52) U.S. Cl. CPC G01S 7/497; G01S 17/89; G01S 17/931; G05B 13/0265

(57) ABSTRACT

A sensor calibration system for calibrating a sensor system associated with a device under test and methods for making and using same. The sensor calibration system can include a turntable system for supporting and rotating the device under test relative to at least one calibration target system and one or more imaging systems distributed about a periphery of the turntable system. The calibration target system can comprise a calibration target device with calibration indicia and a calibration target positioning system for positioning the calibration target device relative to the sensor system; whereas, the imaging systems can capture an image of the device under test as the turntable system rotates the device under test. In selected embodiments, the calibration target system advantageously can calibrate sensor systems that support one or more Advanced Driver Assistance (ADAS) and Autonomous Vehicle (AV) applications when the sensor systems are associated with a passenger vehicle.

### CROSS- REFERENCE TO RELATED APPLICATIONS

This application claims the benefit of, and priority to, U.S. Provisional Application Serial No. 63/276,823, filed on Nov. 8, 2021, the disclosure of which is hereby incorporated herein by reference in its entirety and for all purposes.

### FIELD

The disclosed embodiments relate generally to data processing systems and more particularly, but not exclusively, to data processing systems and methods suitable for performing automated extrinsic calibration of lidars, cameras, radars and ultrasonic sensors on vehicles and robots.

### BACKGROUND

Sensors, such as cameras, lidars, radars and ultrasonics, are starting to become ubiquitous in modern consumer vehicles. Such sensors enable a number of key Advanced Driver Assistance (ADAS) applications such as Backup Monitoring, Lane Keep Assist, Lane Departure Warning, Lane Centering, Automatic Emergency Braking, Forward Collision Warning, Pedestrian and Cyclist Emergency Braking, Adaptive Cruise Control, Blind Spot Monitoring, etc. Further, such sensors are also used for a number of robotics applications such as warehouse automation tasks, autonomous driving, unmanned aerial vehicles, etc.

One requirement for a functional sensor system is precise extrinsic and intrinsic calibration. Intrinsic calibration is needed to understand a relationship between internal transmitters, detectors and pixels and the direction of the incoming signal that ultimately forms a two-dimensional or three-dimensional image of the world. Extrinsic calibration deals with determining the precise spatial transformation between the sensor and the body frame of the vehicle or robot on which the sensor is rigidly installed. These extrinsic parameters change every time the sensor is moved, reinstalled or repositioned relative to the vehicle’s body frame. For instance, cameras attached on the windshield of a vehicle will experience a change in extrinsic parameters when the windshield is replaced or reinstalled. Sometimes, changing the ride height of the vehicle by swapping with larger wheels can also lead to a changed extrinsic calibration as the sensor now views the road from a larger height above ground level. These are just a few examples of scenarios that require extrinsic calibration of the sensors.

Inaccurate calibration can lead to disastrous outcomes in driver assistance. For example, a poorly calibrated forward-facing camera or lidar that is misaligned by just two degrees can incorrectly position a vehicle that is two hundred feet ahead into its adjacent lane and thereby lead to a potential accident.

The state-of-the-art solutions in the market for extrinsic static sensor calibration are very manual in their process. The typical solution involves using:
a plumbline and laser pointer or line marker for measuring the vehicle centerline;
a multitude of measuring tapes to measure accurate distance and manually place an adjustable jig in front of vehicle at a specific distance;
wheel clamps with laser dot based manual system for adjusting the jig to be perpendicular to vehicle centerline at the right distance;
manual adjustment of height of jig to be at right height needed for specific vehicle’s calibration procedure;
manual placement of printed stationary targets on the jig with the correct orientation;
ensuring sufficient lighting and reduced clutter behind calibration area; and
ensuring sufficient working area in well-lit area with perfectly flat ground.

Each of these requirements make the calibration task extremely complicated. The requirements require hours of human intervention and rely heavily on the technician’s measurement skills and attention to detail. One small mistake or omission can lead to incorrect calibration that has severe implications for the intended driver assistance use case of the camera.

In view of the foregoing, a need exists for an improved system and method for performing automated extrinsic calibration of lidars, cameras, radars and ultrasonic sensors on vehicles and robots that overcomes the aforementioned obstacles and deficiencies of currently-available systems.

### BRIEF DESCRIPTION OF THE DRAWINGS

FIG. 1 is a high level block diagram illustrating an exemplary embodiment of an automated extrinsic calibration system for a device under test that is associated with a sensor system disposed at a turntable system.

FIG. 2A is a high level block diagram illustrating an exemplary alternative embodiment of the automated extrinsic calibration system of FIG. 1, wherein the automated extrinsic calibration system includes a robotic arm for positioning a first selected calibration target device at a first predetermined distance from the device under test.

FIG. 2B is a high level block diagram illustrating an exemplary alternative embodiment of the automated extrinsic calibration system of FIG. 2A, wherein the robotic arm positions a second selected calibration target device at a second predetermined distance from the device under test.

FIG. 3 is a detail drawing illustrating another exemplary alternative embodiment of the automated extrinsic calibration system of FIG. 1, wherein the automated extrinsic calibration system includes a pair of Light Detection and Ranging (or LiDAR) systems disposed about a periphery of the turntable system.

FIG. 4A is a high level flow chart illustrating an exemplary embodiment of an automated extrinsic calibration method for the device under test of FIG. 1.

FIG. 4B is a high level flow chart illustrating an exemplary alternative embodiment of the automated extrinsic calibration method of FIG. 4A, wherein the automated extrinsic calibration method includes scanning the device under test.

FIG. 5A is a high level flow chart illustrating an exemplary alternative embodiment of the automated extrinsic calibration method of FIG. 4B, wherein the automated extrinsic calibration method includes identifying the device under test.

FIG. 5B is a high level flow chart illustrating another exemplary alternative embodiment of the automated extrinsic calibration method of FIGS. 4A-B, wherein the automated extrinsic calibration method includes positioning a selected target calibration device relative to the device under test.

FIG. 6A is a detail drawing illustrating a top view of still another exemplary alternative embodiment of the automated extrinsic calibration system of FIG. 1, wherein the automated extrinsic calibration system is configured to calibrate a sensor system associated with a passenger vehicle.

FIG. 6B is a detail drawing illustrating a side view of the automated extrinsic calibration system of FIG. 6A.

FIG. 7 is a detail drawing illustrating yet another exemplary alternative embodiment of the automated extrinsic calibration system of FIG. 1, wherein the automated extrinsic calibration system is configured to perform a static sensor system calibration.

FIG. 8A is a detail drawing illustrating an exemplary alternative embodiment of the automated extrinsic calibration system of FIGS. 2A-B, wherein the calibration target device comprises a calibration target device with first calibration indicia for calibrating a camera imaging system associated with the device under test.

FIG. 8B is a detail drawing illustrating an exemplary alternative embodiment of the calibration target device for calibrating the camera imaging system of FIG. 8A, wherein the calibration target device includes second calibration indicia for calibrating the camera imaging system.

FIG. 9A is a detail drawing illustrating another exemplary alternative embodiment of the automated extrinsic calibration system of FIGS. 2A-B, wherein the calibration target device comprises a calibration target device with first calibration indicia for calibrating a LiDAR imaging system associated with the device under test.

FIG. 9B is a detail drawing illustrating an exemplary alternative embodiment of the calibration target device for calibrating the camera imaging system of FIG. 9A, wherein the calibration target device includes second calibration indicia for calibrating the LiDAR imaging system.

FIG. 10A is a detail drawing illustrating still another exemplary alternative embodiment of the automated extrinsic calibration system of FIGS. 2A-B, wherein the calibration target device comprises a calibration target device with first calibration indicia for calibrating a RADAR imaging system associated with the device under test.

FIG. 10B is a detail drawing illustrating an exemplary alternative embodiment of the calibration target device for calibrating the camera imaging system of FIG. 10A, wherein the calibration target device includes second calibration indicia for calibrating the RADAR imaging system.

FIG. 11A is a detail drawing illustrating a top view of still another exemplary alternative embodiment of the automated extrinsic calibration system of FIG. 1, wherein the automated extrinsic calibration system is configured to calibrate the sensor system that is associated with a front region of the device under test.

FIG. 11B is a detail drawing illustrating a top view of still another exemplary alternative embodiment of the automated extrinsic calibration system of FIG. 1, wherein the automated extrinsic calibration system is configured to calibrate the sensor system that is associated with a side region of the device under test.

FIG. 11C is a detail drawing illustrating a top view of still another exemplary alternative embodiment of the automated extrinsic calibration system of FIG. 1, wherein the automated extrinsic calibration system is configured to calibrate the sensor system that is associated with a rear region of the device under test.

FIG. 12 is a detail drawing illustrating an embodiment of a control system of the automated extrinsic calibration system of FIG. 3.

FIG. 13 is a detail drawing illustrating an embodiment of a three-dimension reconstruction system of the control system of FIG. 12, wherein the three-dimension reconstruction system can reconstruct a registered point cloud image of the device under test.

FIG. 14 is a detail drawing illustrating an embodiment of a machine learning system of the control system of FIG. 12, wherein the machine learning system can decipher one or more aspects and/or segments of the device under test based upon the registered point cloud image.

FIG. 15 is a detail drawing illustrating an embodiment of a target placement simulator system of the control system of FIG. 12, wherein the target placement simulator system can be used for designing calibration procedures for specific types of devices under test and sensor systems.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

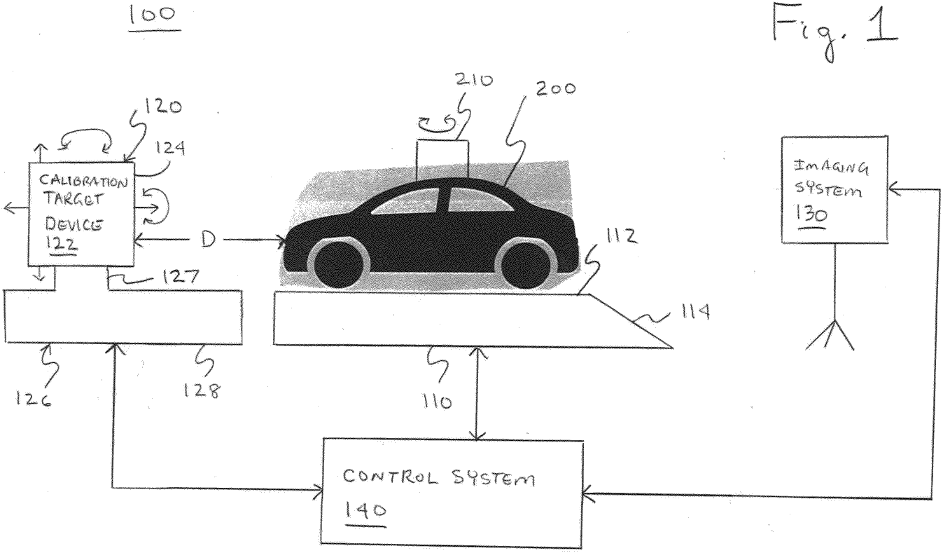

In view of complicated, manual requirements of conventional extrinsic static sensor calibration processes, a system and method for performing automated extrinsic calibration of lidars, cameras, radars and ultrasonic sensors can prove desirable and provide a basis for a wide range of applications, such as calibration of sensors associated with vehicles and/or robots. This result can be achieved, according to one embodiment disclosed herein, by a sensor calibration system 100 as illustrated in FIG. 1.

Turning to FIG. 1, the sensor calibration system 100 is shown as including a turntable system 110 for supporting and/or rotating a device under test 200 that can be associated with a sensor system (or circuit) 210. Exemplary devices under test 200 can include, but are not limited to, a passenger vehicle, a self-driving vehicle, an unmanned aerial vehicle and/or a robotic system. The sensor system 210 can be disposed at any suitable location of the device under test 200. In selected embodiments, the sensor system 210 can be disposed on a preselected surface of the device under test 200 and/or can be at least partially disposed within a preselected region of the device under test 200. The sensor system 210, for example, can be disposed at a roof, a bumper, a grille, a sideview mirror, a rearview mirror and/or a hood of a passenger vehicle.

Exemplary sensor systems 210 can include one or more camera systems, one or more Light Detection and Ranging (or LiDAR) systems, one or more Radio Detection and Ranging (or RADAR) systems and/or one or more ultrasonic systems, without limitation. When associated with a passenger vehicle and/or commercial vehicle, for example, the sensor system 210 can support one or more Advanced Driver Assistance (ADAS) applications, such as Backup Monitoring, Lane Keep Assist, Lane Departure Warning, Lane Centering, Automatic Emergency Braking, Forward Collision Warning, Pedestrian and Cyclist Emergency Braking, Adaptive Cruise Control, Blind Spot Monitoring, etc. The sensor system 210, additionally and/or alternatively, can comprise Autonomous Vehicle (AV) sensor system that can be associated with a passenger vehicle, a commercial vehicle, or any other suitable type of device under test 200.

The sensor calibration system 100 advantageously can perform extrinsic calibration on the sensor system 210. The extrinsic calibration can be performed on the device under test 200 and/or sensor system 210 at any suitable time. For example, the sensor calibration system 100 can perform an initial extrinsic calibration when the sensor system 210 is initially installed on the device under test 200 as original equipment and/or as an aftermarket addition to the device under test 200. The sensor calibration system 100 optionally can support periodic or otherwise time-based extrinsic calibrations on the sensor system 210, such as a part of regular maintenance on the device under test 200. Additionally and/or alternatively, the sensor calibration system 100 can support event-based extrinsic calibrations on the sensor system 210 such as after the device under test 200 and/or the sensor system 210 has been involved in a collision or has otherwise been damaged.

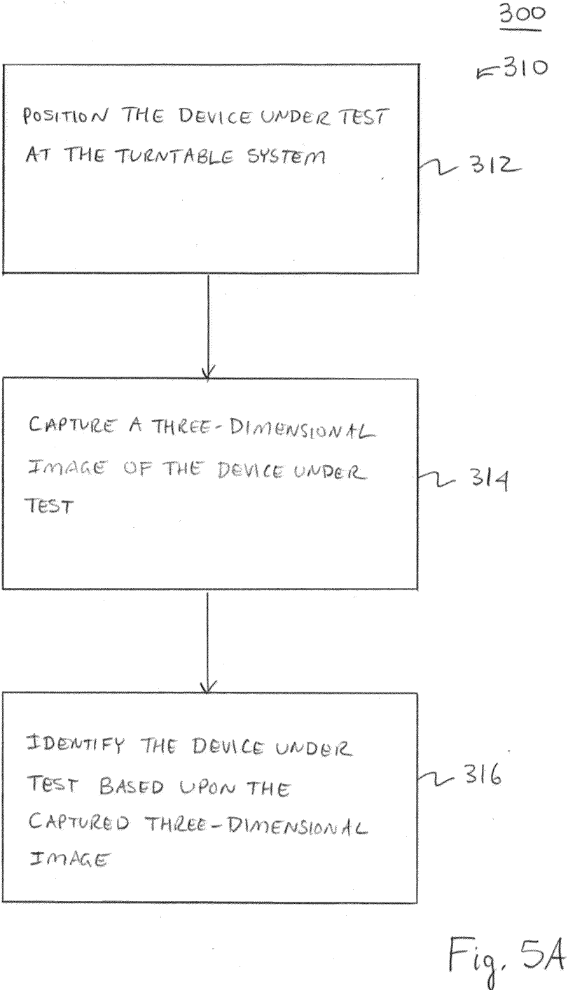

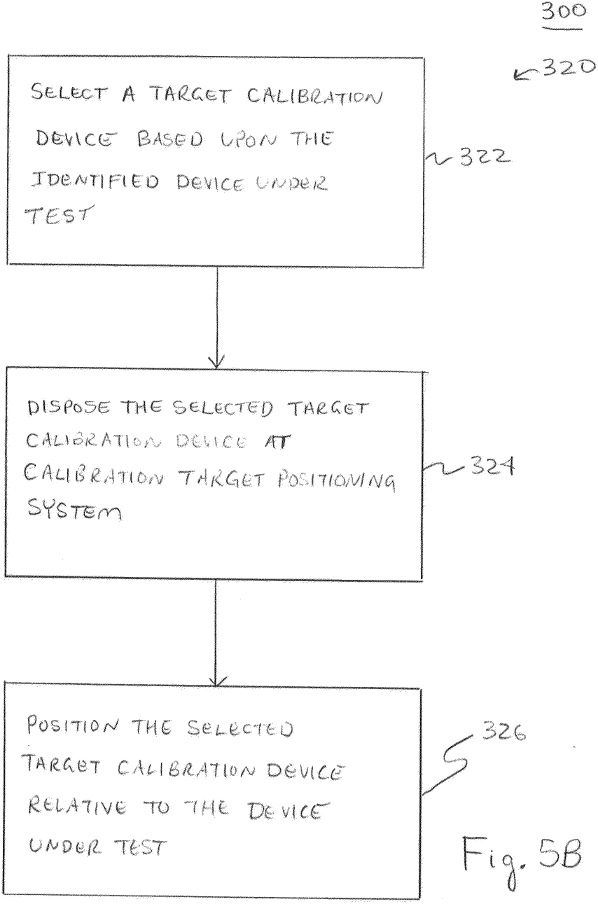

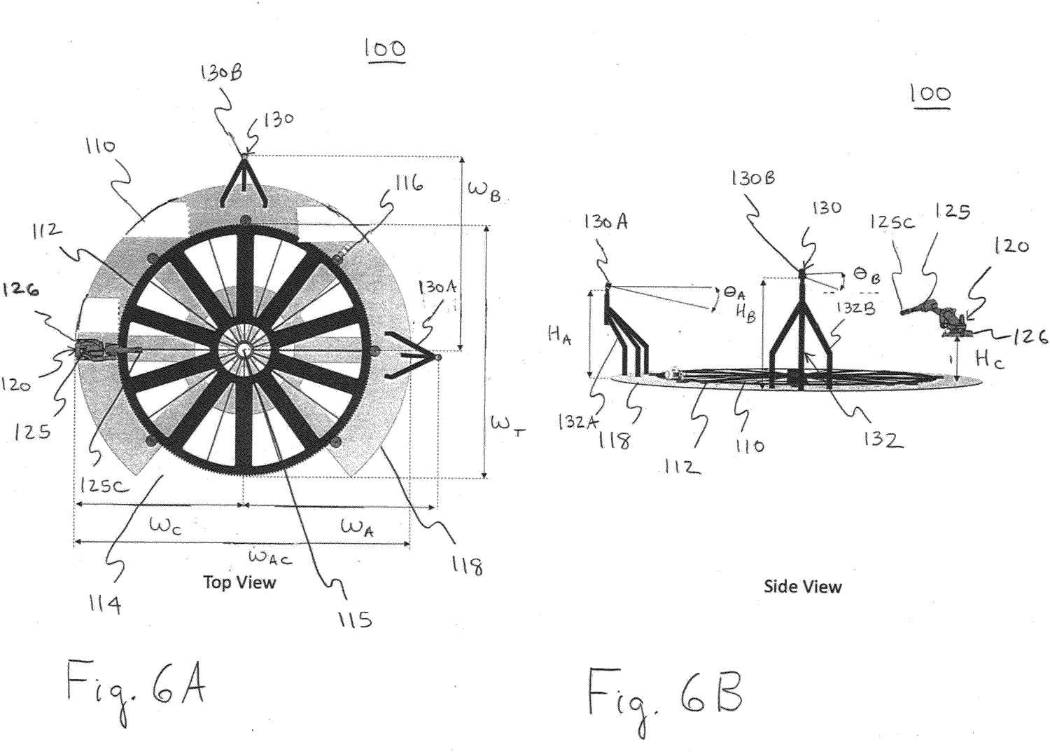

The turntable system 110 can include a turntable motor system 116 (shown in FIG. 6A) for rotating a testing region 112 at which the device under test 200 can be disposed during the extrinsic calibration. If the testing region 112 comprises a recessed testing surface or, as shown in FIG. 1, an elevated testing surface, the turntable system 110 can be associated with a ramp or other inclined region 114 for facilitating disposal of the device under test 200 on the testing region 112. The inclined region 114 can be separate from, or at least partially integrated with, the turntable system 110. The testing region 112 preferably has a suitable size, diameter, shape and/or other dimension for accommodating a variety of devices under test 200 with different shapes, sizes and/or weights.

The sensor calibration system 100 likewise can include at least one calibration target system 120 that can be disposed adjacent to the turntable system 110. The calibration target system 120 can be associated with one or more calibration target devices 122 each having at least one predetermined grid pattern or other calibration indicia 124. At least one calibration target device 122 can be selected for coupling with a calibration target positioning system 126. In selected embodiments, the calibration target devices 122 can include calibration indicia 124 that are associated with respective devices under test 200 and/or sensor systems 210 such that the calibration indicia 124 of the selected calibration target device 122 can be suitable for calibrating the device under test 200 and/or sensor system 210 disposed at the turntable system 110. The calibration target device 122 optionally can include calibration indicia 124 that is associated with more than one device under test 200 and/or sensor system 210 for enabling the calibration target device 122 to be suitable for use during calibration of more than one device under test 200 and/or sensor system 210.

As illustrated in FIG. 1, the calibration target positioning system 126 can arrange the selected calibration target device 122 at a predetermined distance D, elevation, orientation, angle and/or other position attribute relative to the device under test 200 and/or sensor system 210. The calibration target positioning system 126, in other words, can raise and/or lower the selected calibration target device 122 relative to the turntable system 110 and/or the device under test 200 and/or sensor system 210 disposed at the turntable system 110, horizontally, diagonally and/or vertically rotate the selected calibration target device 122 relative to the turntable system 110 and/or the device under test 200 and/or sensor system 210 disposed at the turntable system 110 and/or translate the selected calibration target device 122 relative to the turntable system 110 and/or the device under test 200 and/or sensor system 210 disposed at the turntable system 110. In selected embodiments, the calibration target positioning system 126 itself can translate or otherwise move relative to the device under test 200 and/or sensor system 210 for arranging the predetermined distance D or other position attribute of the selected calibration target device 122. The calibration target positioning system 126, for example, can translate radially toward and/or away from the turntable system 110.

The translation of the selected calibration target device 122 can include, for example, moving the selected calibration target device 122 toward and/or away from the turntable system 110 and/or the device under test 200 and/or sensor system 210 disposed at the turntable system 110. In selected embodiments, the calibration target positioning system 126 can arrange at least one position attribute of the selected calibration target device 122 relative to a predetermined point or location of the device under test 200 and/or sensor system 210. The calibration target positioning system 126 optionally can adjust at least one position attribute, such as the distance D, through a preselected range of position attribute values.

FIG. 1 shows that the calibration target positioning system 126 can include a positioning system base 128 for supporting the calibration target positioning system 126 and a positioning system member 127 for coupling the selected calibration target device 122 with the positioning system base 128. The positioning system base 128 can comprise an elongated base with a proximal end region that is adjacent to the turntable system 110 and a distal end region that is distant from the turntable system 110. Stated somewhat differently, the proximal end region of the positioning system base 128 can be disposed between the distal end region of the positioning system base 128 and the turntable system 110. The positioning system member 127 thereby can traverse between the proximal and distal end regions of the positioning system base 128 for adjusting the distance D between the selected calibration target device 122 and the turntable system 110 and/or the device under test 200 and/or sensor system 210.

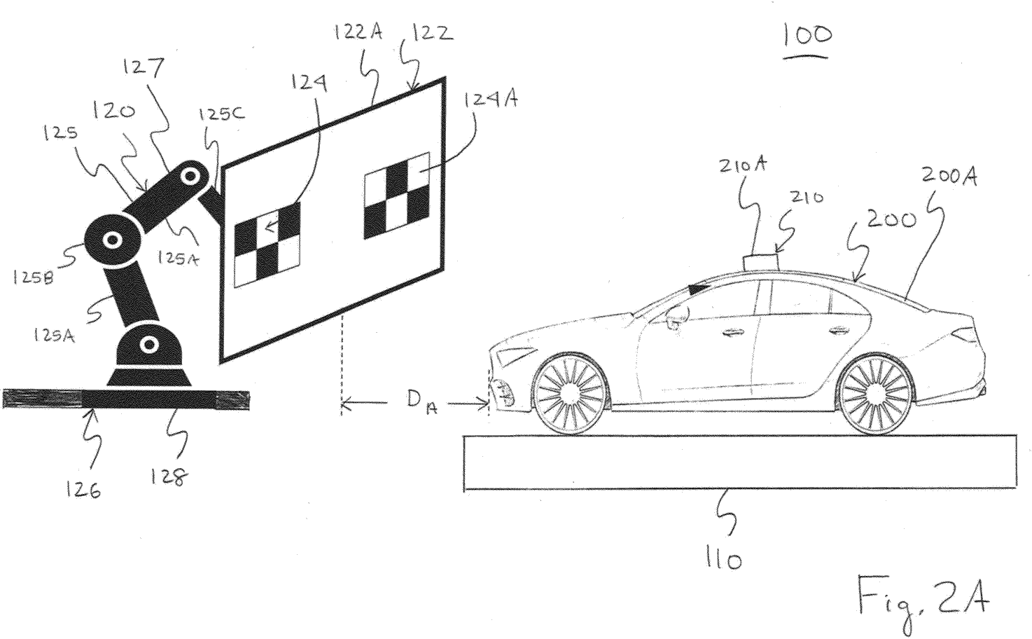

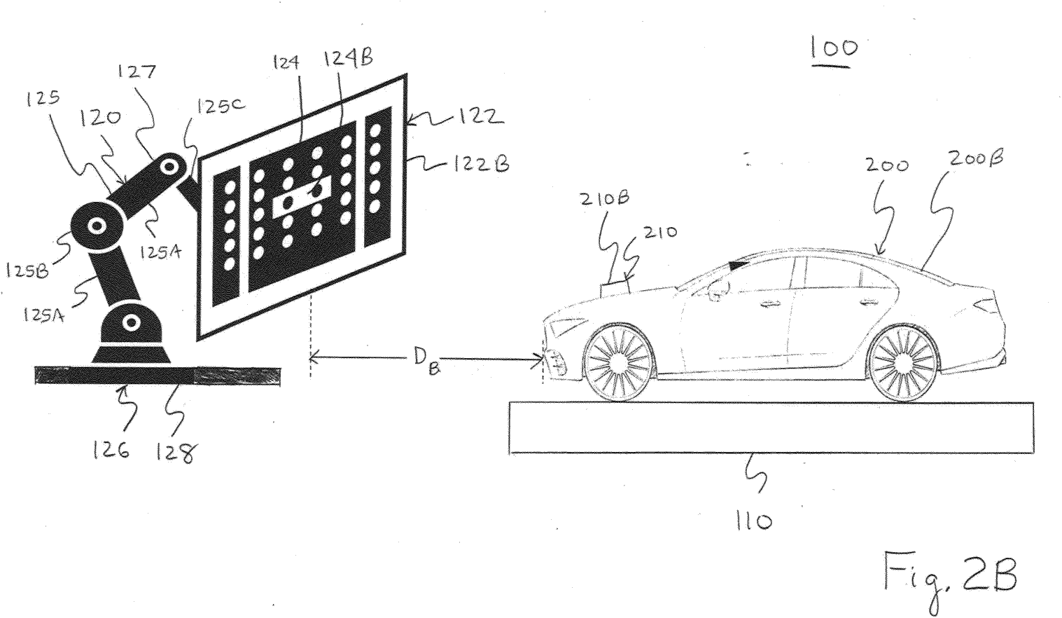

In selected embodiments, the calibration target positioning system 126 can arrange at least one position attribute of the selected calibration target device 122 relative to the device under test 200 and/or sensor system 210 in an automated manner. The calibration target positioning system 126, for example, can comprise a robot, wherein the positioning system member 127 comprises a robotic arm 125 as illustrated in FIGS. 2A-B. Turning to FIG. 2A, the robotic arm 125 is shown as comprising an articulated robotic arm with a plurality of arm segment members 125A and an arm joint member 125B disposed between each pair of adjacent segment members 125A. In selected embodiments, at least one of the arm joint members 125B can comprise a rotary joint member, a rotational joint member and/or a prismatic joint member. A proximal arm segment member 125A can be coupled with the positioning system base 128 directly or, as shown in FIG. 2A, via an arm joint member 125B; whereas, a distal arm segment member 125A can comprise an end effector member 125C for coupling with the selected calibration target device 122.

The sensor calibration system 100 advantageously incorporates a high degree of generalization and can support a wide range of calibration procedures. For instance, the sensor calibration system 100 can perform calibration procedures for a camera-based, RADAR-based and/or Lidar-based sensor systems 210. The sensor calibration system 100 likewise can be programmatically controlled and/or perform calibration procedures for any device under test 200 associated with any brand, type or other identifying attribute.

As illustrated in FIGS. 2A-B, for example, the sensor calibration system 100 is shown as accommodating two different devices under test 200A, 200B, respectively. The first device under test 200A can have a first sensor system 210A that is different from a second sensor system 210B of the second device under test 200B. The first sensor system 210A, for example, can have a first sensor type that is different from a second sensor type of the second sensor system 210B. Additionally and/or alternatively, the first sensor system 210A can be disposed at a first location of the first device under test 200A; whereas, the second sensor system 210B can be disposed at a second location of the second device under test 200B.

The first sensor type of the first sensor system 210A can necessitate selection of a first calibration target device 122A with first calibration indicia 124A. Similarly, the second sensor type of the second sensor system 210B can necessitate of a second selected calibration target device 122B with second calibration indicia 124B. In selected embodiments, the calibration target positioning system 126 can arrange the first calibration target device 122A at a first predetermined distance D_{A}, elevation, orientation, angle and/or other position attribute relative to the first device under test 200A and/or the first sensor system 210A in the manner discussed in more detail above with reference to FIG. 1.

The first position attributes of the first calibration target device 122A can be based, for example, upon the first sensor type and/or the first location of the first sensor system 210A. The calibration target positioning system 126 likewise can arrange the second calibration target device 122B at a second predetermined distance D_{B}, elevation, orientation, angle and/or other position attribute relative to the second device under test 200B and/or the second sensor system 210B as set forth above. For instance, the second position attributes of the second calibration target device 122B can be based upon the second sensor type and/or the second location of the second sensor system 210B. The first and second predetermined distances D_{A}, D_{B} can comprise any suitable predetermined distance. Exemplary predetermined distances can include one or more predetermined distances, such as fifteen hundred millimeters and three thousand millimeters, and/or at least one predetermined distance range, such as between fifteen hundred millimeters and three thousand millimeters, including any preselected distance subranges within a predetermined distance range, without limitation.

Returning to FIG. 1, one or more imaging systems (or circuits) 130 are shown as being disposed adjacent to the turntable system 110. Exemplary imaging systems 130 can include, but are not limited to, a LiDAR imaging system (or circuit), a RADAR imaging system (or circuit) and/or a camera system (or circuit). In selected embodiments, the LiDAR imaging system can comprise a high-precision three-dimensional LiDAR imaging system and/or an industrial-grade two-dimensional LiDAR imaging system; whereas, the camera imaging system can include a high fidelity camera. The imaging systems 130 preferably comprise uniform imaging systems of the same type but, in selected embodiments, can include at least one imaging system of a different type. The calibration target system 120 and the imaging systems 130 can be distributed about a periphery of the turntable system 110 in any suitable manner. The imaging systems 130 can be disposed at respective predetermined distances, elevations, orientations, angles and/or other position attributes relative to the device under test 200 and/or sensor system 210.

The turntable system 110 can rotate the device under test 200 and/or sensor system 210 relative to the calibration target system 120 and the imaging systems 130 during an extrinsic sensor calibration process. As desired, the turntable system 110 can rotate the device under test 200 and/or sensor system 210 about a central axis of rotation of the turntable system 110 in a clockwise direction and/or in a counter clockwise direction. The turntable system 110 likewise can rotate the device under test 200 and/or sensor system 210 through one or more full revolutions and/or can rotate the device under test 200 and/or sensor system 210 by a predetermined percentage of a revolution. The direction and/or amount of rotation can be based, at least in part, upon a requirement of the extrinsic sensor calibration process. In selected embodiments, the calibration target system 120 and/or the imaging systems 130 can remain static (or motionless) and/or dynamic (or in motion) as the turntable system 110 rotates the device under test 200 and/or sensor system 210.

The extrinsic sensor calibration process preferably comprises an automated extrinsic sensor calibration process. The sensor calibration system 100 is shown in FIG. 1 as included an optional control system (or circuit) 140 for controlling or otherwise automating the extrinsic sensor calibration process. For example, the control system 140 can be configured to control operation of the turntable system 110, the calibration target system 120 and/or the imaging system 130. The control system 140 can comprise a processing system (or circuit), such as a computer server system, a personal computing system, laptop computing system, tablet computing system, mobile telephone system or any other conventional type of processing system suitable for controlling the turntable system 110, the calibration target system 120 and/or the imaging system 130. Preferably, the control system 140 can include a high-precision controller and encoder system (or circuit) (not shown) and/or one or more on-board high clock-rate central processing units (CPUs) and/or graphics processing units (GPUs) with internet access. The extrinsic sensor calibration process, in selected embodiments, can comprise a computer-implemented extrinsic sensor calibration process.

The control system 140 can communicate with the turntable system 110, the calibration target system 120 and/or the imaging system 130 in any conventional wired manner and/or wireless manner. The control system 140, for example, can exchange data with the turntable system 110, the calibration target system 120 and/or the imaging system 130 directly or via a computer network (not shown), such as the internet. As illustrated in FIG. 3, the control system 140 can include a turntable control system (or circuit) 142 for controlling operation of the turntable system 110, a calibration target control system (or circuit) 144 for controlling operation of the calibration target system 120 and/or an imaging control system (or circuit) (not shown) for controlling the imaging system 130.

The turntable control system 142, for example, can include an optional high-precision controller and encoder system (or circuit) 142A (shown in FIG. 13) for recording encoder angles as the turntable system 110 rotates. The turntable control system 142, the calibration target control system 144 and the imaging control system can comprise separate control systems and/or can be at least partially integrated into at least one combined control system. In selected embodiments, the control system 140 can include a control station for providing a user interface 148 for enabling a system operator or other system user (not shown) to interact with the sensor calibration system 100.

As shown in FIG. 3, the sensor calibration system 100 can include the calibration target system 120 and a pair of imaging systems 130 disposed about the central turntable system 110. The calibration target system 120 can comprise the robotic arm 125 with the selected calibration target device 122 being coupled with the end effector member 125C. The imaging systems 130 are illustrated as including a first imaging system 130A and a second imaging system 130B. The first and second imaging systems 130A, 130B can be disposed in any suitable configuration relative to the calibration target system 120.

The first imaging system 130A, for instance, is shown as opposing the calibration target system 120 across the central turntable system 110. In other words, the first imaging system 130A and the calibration target system 120 can be disposed in a plane that comprises opposite ends of a diameter of the central turntable system 110 and passing through a center (or central region) 115 (shown in FIG. 6A) of the turntable system 110. The second imaging system 130B can be disposed in a position that is normal to the plane of the first imaging system 130A and the calibration target system 120. Stated somewhat differently, the second imaging system 130B and the first imaging system 130A can define a right angle at the central region 115, and/or the second imaging system 130B and the calibration target system 120 can define a right angle at the central region 115.

Although shown in FIGS. 1-3 as comprising a single calibration target system 120 and a single imaging system 130 for purpose of illustration only, the sensor calibration system 100 can include any suitable number of calibration target systems 120 and/or any suitable number of imaging systems 130. The calibration target systems 120 can comprise a first calibration target system 120 that can be the same as, or different from, a second calibration target system 120. The first calibration target system 120, for example, can be associated with a first selected calibration target device 122A (shown in FIG. 2A); whereas, the second calibration target system 120 can be associated with a second selected calibration target device 122B (shown in FIG. 2B) that is different from the first selected calibration target device 122.

Additionally and/or alternatively, the imaging systems 130 can comprise a first imaging system 130A (shown in FIG. 3) that can be the same as, or different from, a second imaging system 130B (shown in FIG. 3). If the first imaging system 130A comprises a first LiDAR system, for example, the second imaging system 130B can include a second LiDAR system if the first and second imaging systems 130A, 130B are the same. In contrast, if the first and second imaging systems 130A, 130B are different, the second imaging system 130B can include a RADAR system.

Although shown and described as comprising a central turntable 110 for rotating the device under test 200 and/or the sensor system 210 for purposes of illustration only, the sensor calibration system 100 can be configured to rotate the calibration target system(s) 120 and/or the imaging system(s) 130 about a stationary device under test 200 and/or sensor system 210 in selected embodiments.

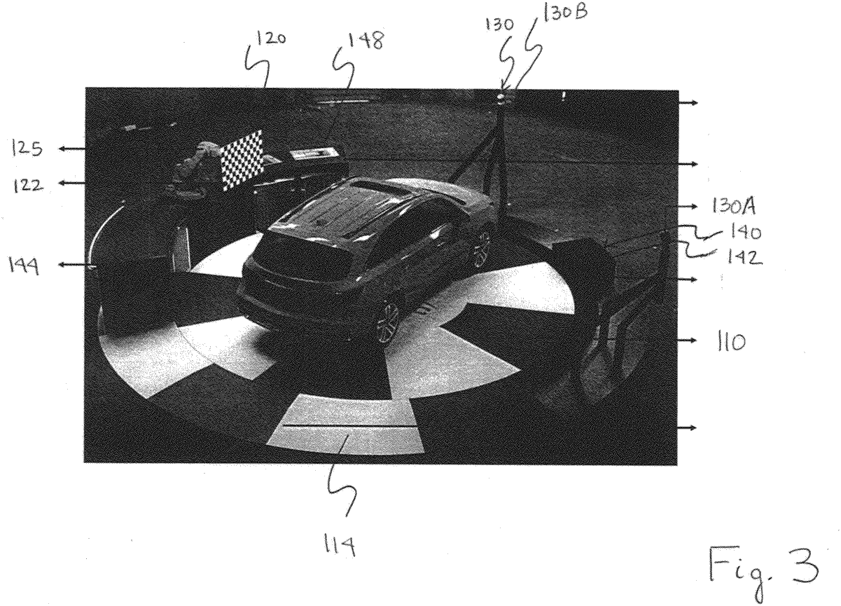

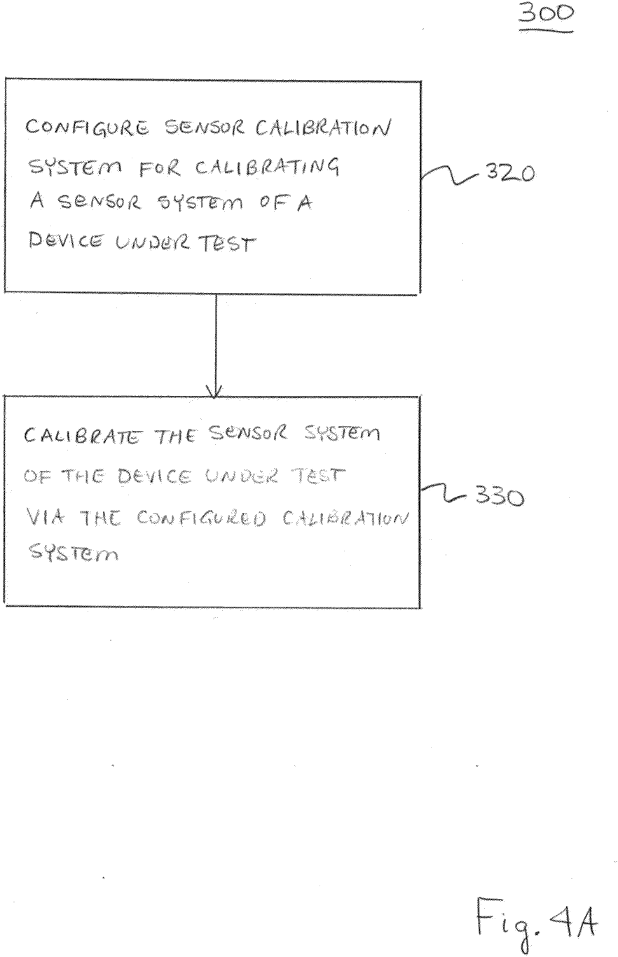

In operation, the sensor calibration system 100 advantageously can perform an extrinsic calibration method on the sensor system 210. An exemplary extrinsic calibration method 300 is illustrated in FIGS. 4A-B. The extrinsic calibration method 300 can include instruction for configuring and controlling the sensor calibration system 100. In selected embodiments, the sensor calibration system 100 can be controlled and configured via software that can be executed by the control system 140 (shown in FIG. 1). The extrinsic calibration method 300, in other words, can comprise a computer-implemented extrinsic calibration method in selected embodiments.

Turning to FIG. 4A, the extrinsic calibration method 300 is shown as including, at 320, configuring the sensor calibration system 100 (shown in FIG. 1) for calibrating a sensor system 210 (shown in FIG. 1) associated with a relevant device under test 200 (shown in FIG. 1). The sensor system 210 of the device under test 200 can be calibrated, at 330, via the configured sensor calibration system 100. In selected embodiments, the extrinsic calibration method 300 can comprise an automated extrinsic sensor calibration process. The extrinsic calibration method 300, in other words, can be controlled or otherwise automated via a processing system (or circuit) such as the control system 140 (shown in FIG. 1).

An alternative embodiment of the extrinsic calibration method 300 is shown in FIG. 4B. As illustrated in FIG. 4B, the extrinsic calibration method 300 can include, at 310, scanning a relevant device under test 200 (shown in FIG. 1) that is associated with a sensor system 210 (shown in FIG. 1). The sensor calibration system 100 can be configured, at 320, for use with the scanned device under test 200. In other words, the sensor calibration system 100, at 320A, can be configured for calibrating the sensor system 210 of the scanned device under test 200. At 330A, the sensor system 210 of the scanned device under test 200 can be calibrated via the configured sensor calibration system 100.

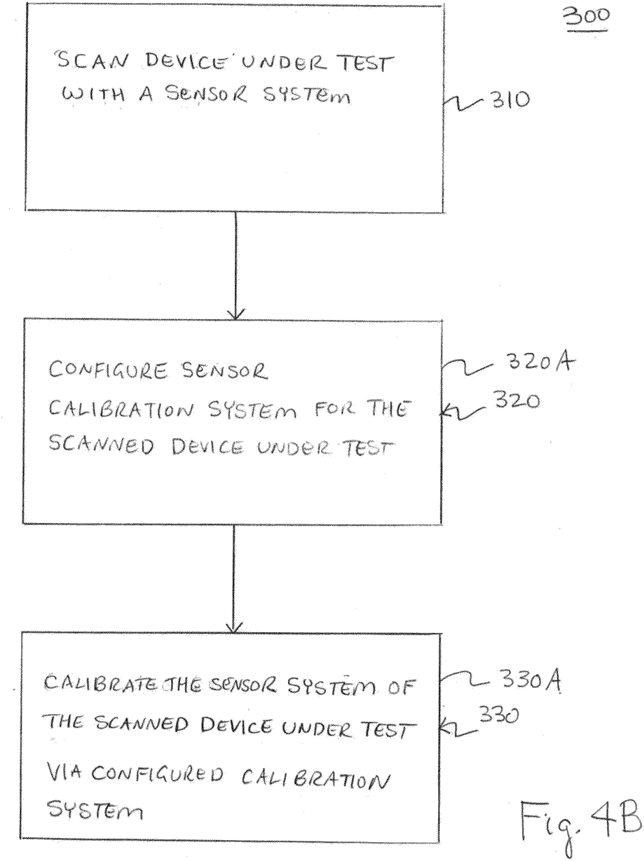

The relevant device under test 200 can be scanned, at 310, in any suitable matter. Turning to FIG. 5A, for example, the relevant device under test 200 can be scanned, at 312, by positioning the device under test 200 at the turntable system 110 (shown in FIG. 1). In selected embodiments, the relevant device under test 200 can be disposed on the testing region 112 (shown in FIG. 1) of the turntable system 110. As the turntable system 110 with the relevant device under test 200 rotates at a predetermined rotational speed, a three-dimensional image of the relevant device under test 200 can be captured, at 314. The three-dimensional image of the relevant device under test 200 can be captured, at 314, for example, can be captured via the imaging system(s) 130 (shown in FIG. 1).

If the imaging system 130 includes a three-dimensional LiDAR imaging system, the turntable system 110 preferably can rotate at a low, fixed rotational speed for enabling the three-dimensional LiDAR imaging system to construct or otherwise capture a complete three-dimensional registered point cloud image 136 (shown in FIG. 13) of the relevant device under test 200 as the relevant device under test 200 rotates with the turntable system 110. Exemplary rotational speeds can include, but are not limited to, any rotational speed within a rotational speed range between one-twentieth of a rotation per second and ten rotations per second. In selected embodiments, the rotational speed can comprise a rotational speed within a rotational speed range between one-tenth of a rotation per second and four rotations per second. Capturing the three-dimensional registered point cloud image optionally can include capturing a sparse three-dimensional registered point cloud image of the rotated device under test 200 and/or capturing a dense three-dimensional registered point cloud image of the rotated device under test 200. Any noisy points in the three-dimensional registered point cloud image 136 of the relevant device under test 200 optionally can be filtered.

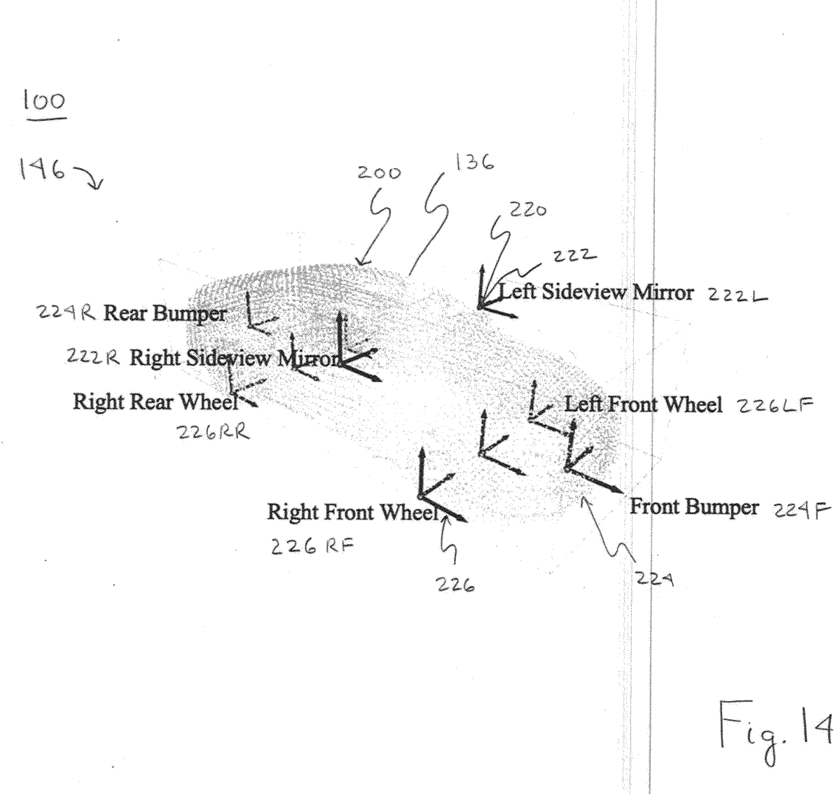

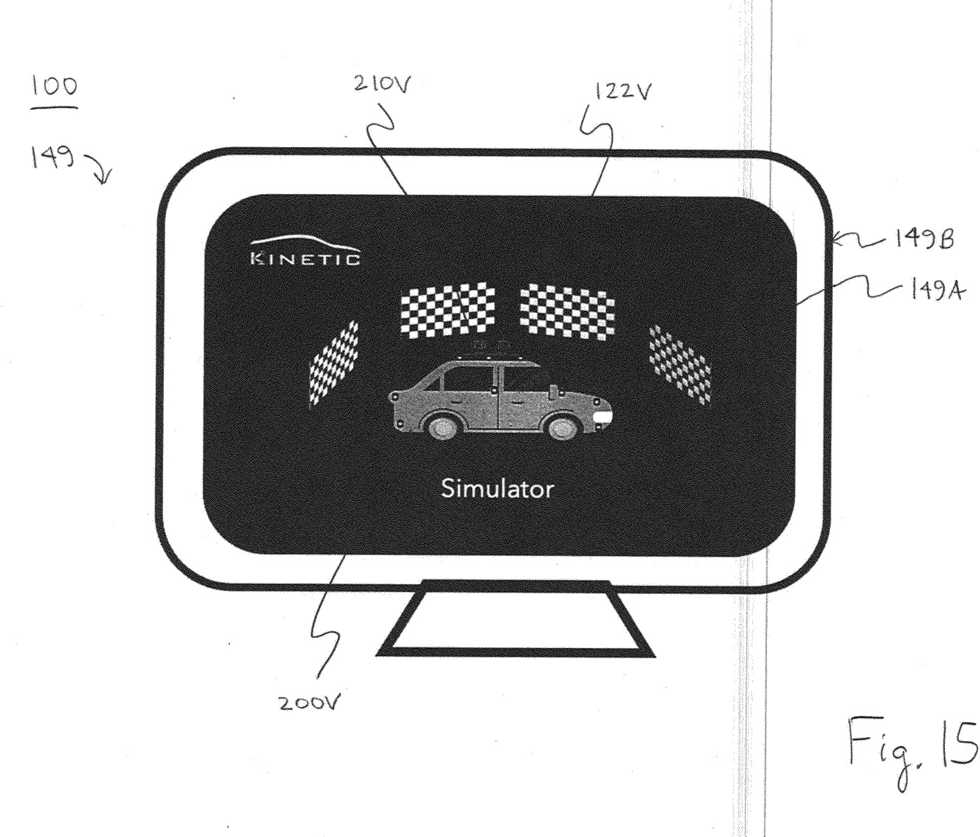

At 316, the relevant device under test 200 can be identified based upon the captured three-dimensional image of the relevant device under test 200. The relevant device under test 200 can be identified, for example, by extracting one or more relevant markers or other device components 220 (shown in FIG. 14) from the captured three-dimensional image of the relevant device under test 200. Exemplary markers can include, but are not limited to, a bumper, a side-view mirror, a wheel center, an axle center, a vehicle logo, a vehicle thrust line, a door and/or a pillar if the relevant device under test 200 comprises a passenger vehicle. Based upon the extracted markers, a make, model and/or any other identifying (or attribute) device information of the relevant device under test 200 can be determined. Identifying sensor information, such as a sensor type and/or a sensor location, of the sensor system 210 optionally can be determined based upon the extracted markers, the identifying device information and/or the identified device under test 200.

Once the relevant device under test 200 has been identified, the sensor calibration system 100 (shown in FIG. 1), can be configured for the relevant device under test 200, at 320A (shown in FIG. 4B). The sensor calibration system 100, in other words, can be configured for calibrating the sensor system 210 of the scanned device under test 200. As shown in FIG. 5B, for example, at least one calibration target device 122 (shown in FIG. 1) can be selected, at 322, for coupling with a calibration target positioning system 126 (shown in FIG. 1) once the relevant device under test 200 has been identified. At 324, the selected calibration target device 122 can be disposed at the calibration target positioning system 126 (shown in FIG. 1).

The selected calibration target device 122, in selected embodiments, can be coupled with the calibration target positioning system 126 in the manner discussed in more detail above with reference to FIGS. 1 and 2A-B. The calibration target positioning system 126 then can position, at 326, the selected calibration target device 122 relative to the device under test 200 disposed at the turntable system 110. In selected embodiments, the calibration target positioning system 126 can arrange the selected calibration target device 122 at the predetermined distance D, elevation, orientation, angle and/or other position attribute relative to the device under test 200 and/or sensor system 210 in the manner discussed in more detail above with reference to FIGS. 1 and 2A-B.

Returning briefly to FIG. 4B, the sensor system 210 of the scanned device under test 200 can be calibrated, at 330A, after the selected calibration target device 122 has been selected and positioned. The control system 140 (shown in FIG. 1), for example, can control or otherwise automate the extrinsic sensor calibration process. The control system 140 can be configured to control operation of the turntable system 110 (shown in FIG. 1), the calibration target system 120 (shown in FIG. 1) and/or the imaging system 130 (shown in FIG. 1). In selected embodiments, the control system 140 can adjust at least one position attribute, a path plan and/or a speed of the calibration target system 120 during calibration, at 330A, of the sensor system 210.

Calibration data acquisition can be manually and/or automatically initiated at the device under test 200. In selected embodiments, the calibration data for calibrating the sensor system 210 can be captured and/or stored at the device under test 200. The calibration procedure for the sensor system 210 can be run in real time at the device under test 200 and/or can be uploaded for execution and validate at a later date. For example, the calibration procedure can be uploaded to the device under test 200 or to a separate data storage system (or circuit) (not shown) such as the cloud. Once the calibration procedure is completed, the device under test 200 can be removed from the turntable system 110, and the sensor calibration system 100 can return to a default state.

Accordingly, the sensor calibration system 100 and/or the extrinsic calibration method 300 can perform extrinsic calibration or re-calibration, as needed, for the sensor system 210. The sensor calibration system 100 and/or the extrinsic calibration method 300 can rapidly perform highly-precise, factory-level calibration of the sensor system 210 with minimal, if any, user intervention to restore and/or maintain optimal functionality. Advantageously, the sensor calibration system 100 and/or the extrinsic calibration method 300 can leverage high-precision calibration target systems 120 and imaging systems 130 for performing the calibration procedure for a wide range of sensor systems 210 and devices under test 200 in a very precise manner.

In selected embodiments, the sensor calibration system 100 can calibrate a sensor system 210 that is associated with a passenger vehicle, such as an automobile, truck or van. The sensor calibration system 100 of FIGS. 6A-B is shown as being configured to calibrate the sensor system 210 (shown in FIG. 1) that is associated with the passenger vehicle. Turning to FIG. 6A, the sensor calibration system 100 is shown including the calibration target system 120 and a pair of imaging systems 130 disposed about the central turntable system 110 in the manner described in more detail above with reference to FIG. 3. The calibration target system 120, for example, can comprise the robotic arm 125 with the end effector member 125C for coupling with the selected calibration target device 122 (shown in FIG. 3). As illustrated in FIG. 6A, the imaging systems 130 can comprise a first imaging system 130A and a second imaging system 130B. The first and second imaging systems 130A, 130B, for example, can comprise LiDAR imaging systems and/or can be disposed in any suitable configuration relative to the calibration target system 120.

The turntable system 110 is shown as having a testing region 112 with a predetermined diameter W_{T} for supporting, rotating or otherwise accommodating the passenger vehicle. The predetermined diameter W_{T} can be within a diameter range between one meter and ten meters, or more. In selected embodiments, the predetermined diameter W_{T} can be within a preselected diameter subrange of the diameter range, such as a preselected two-meter diameter subrange between four meters and six meters and/or a preselected four-meter diameter subrange between four meters and eight meters. The predetermined diameter W_{T} of the testing region 112 preferably can comprise a suitable dimension for accommodating a variety of passenger vehicles with different shapes, sizes and/or weights.

A periphery of the testing region 112 can be at least partially encircled or otherwise enclosed by a testing apron region 118. In other words, the testing apron region 118 can be concentric relative to the turntable system 110 in selected embodiments. The testing apron region 118 can have a predetermined inner diameter that is substantially equal to or greater than the predetermined diameter W_{T} of the testing region 112 and a predetermined outer diameter W_{AC} that is greater than the predetermined inner diameter of the testing apron region 118. A width of the testing apron region 118 can be within a range between one meter and ten meters, or more. In selected embodiments, the predetermined outer diameter W_{AC} of the testing apron region 118 can be within a preselected diameter subrange of the diameter range, such as a preselected four-meter diameter subrange between the predetermined inner diameter and the predetermined outer diameter W_{AC} of the testing apron region 118. If the predetermined diameter W_{T} of the testing region 112 is six meters, the predetermined inner diameter of the testing apron region 118 can be approximately equal to six meters, and the predetermined outer diameter W_{AC} can be equal to twelve meters.

As illustrated in FIG. 6A, at least one calibration target system 120 and/or at least one imaging system 130 can be disposed within the testing apron region 118. The calibration target system 120 and/or the imaging system 130 can be fixedly disposed on the testing apron region 118 in selected embodiments. The first imaging system 130A is shown as being disposed on the testing apron region 118 opposite the calibration target system 120 across the turntable system 110. In other words, the first imaging system 130A and the calibration target system 120 can be disposed in a plane that comprises opposite ends of a diameter of the central turntable system 110 and passing through the central region 115 of the turntable system 110. The calibration target positioning system 126 of the calibration target system 120 is shown as being placed a predetermined distance Wc from the central region 115 of the turntable system 110; whereas, the first imaging system 130A is shown as being placed a predetermined distance W_{A} from the central region 115 of the turntable system 110.

The second imaging system 130B can be disposed within the testing apron region 118 in a position that is normal to the plane of the first imaging system 130A and the calibration target system 120. Stated somewhat differently, the first imaging system 130A and the second imaging system 130B can define a right angle at the central region 115, and/or the calibration target system 120 and the second imaging system 130B can define a right angle at the central region 115. The second imaging system 130B is shown as being placed a predetermined distance W_{B} from the central region 115 of the turntable system 110.

In selected embodiments, the predetermined distance W_{A} between the first imaging system 130A and the central region 115 can be equal to the predetermined distance W_{B} between the second imaging system 130B and the central region 115. The predetermined distance Wc between the calibration target system 120 and the central region 115 can be greater than, less than and/or equal to the predetermined distance W_{A} between the first imaging system 130A and the central region 115 and/or the second imaging system 130B and the central region 115. If the predetermined diameter W_{T} of the testing region 112 is six meters, for example, at least one of the predetermined distances W_{A}, W_{B}, W_{C} can comprise a predetermined distance within a predetermined distance range of three meters and ten meters. In selected embodiments, the predetermined distances W_{A}, W_{B}, W_{C} can be within a preselected diameter subrange of the predetermined distance range, such as a preselected three-meter diameter subrange between three meters and six meters.

The calibration target system 120 is shown in FIG. 6B as being disposed at a predetermined height H_{c} above the testing apron region 118. In selected embodiments, the calibration target positioning system 126 of the calibration target system 120 can be disposed at the predetermined height H_{c} above the testing apron region 118. The predetermined height H_{c} can comprise any suitable predetermined height for proper placement of the calibration indicia 124 relative to the passenger vehicle or sensor system 210 (shown in FIG. 1). Exemplary predetermined heights H_{c} can include, but are not limited to, a height within the predetermined height range between zero meters and six meters. In selected embodiments, the predetermined height H_{c} can be within a preselected height subrange of the predetermined height range, such as a preselected one-meter diameter subrange between zero meters and one meter.

The first and second imaging systems 130A, 130B can be disposed at respective predetermined heights H_{A}, H_{B} above the testing apron region 118. As shown in FIG. 6B, the first and second imaging systems 130A, 130B can be respectively supported by first and second support members 132A, 132B that can be disposed within the testing apron region 118. Each support member 132 can be fixedly disposed on the testing apron region 118 and configured to alternately couple with at least one selected imaging system 130 in selected embodiments. Stated somewhat differently, each support member 132 can couple with at least one of a plurality of imaging systems 130 of the same type and/or or different types.

The first and second predetermined heights H_{A}, H_{B} can comprise any suitable predetermined height for proper placement of the respective first and second imaging systems 130A, 130B relative to the passenger vehicle or sensor system 210. The first predetermined height H_{A} of the first imaging system 130A can be the same as, and/or or different from, the second predetermined height H_{B} of the second imaging system 130B. Exemplary first and second predetermined heights H_{A}, H_{B} can include, but are not limited to, a height within the predetermined height range between zero meters and six meters. In selected embodiments, the first and second predetermined heights H_{A}, H_{B} can be within a preselected height subrange of the predetermined height range, such as a preselected one-and-a-half-meter diameter subrange between one and a half meters and three meters.

Additionally and/or alternatively, the first and second imaging systems 130A, 130B can be disposed at respective first and second predetermined imaging angles Θ_{A}, Θ_{B} relative to the testing region 112. The first imaging system 130A, for example, can be coupled with the first support member 132A and adjusted to the first predetermined imaging angle Θ_{A}; whereas, the second imaging system 130B can be coupled with the second support member 132B and adjusted to the second predetermined imaging angle Θ_{B} as shown in FIG. 6B. The first and second predetermined imaging angles Θ_{A}, ⊝_{B} can comprise any suitable predetermined imaging angle for imaging the passenger vehicle or sensor system 210. The first predetermined imaging angle Θ_{A} of the first imaging system 130A can be the same as, and/or or different from, the second predetermined imaging angle Θ_{B} of the second imaging system 130B.

Exemplary first and second predetermined imaging angles Θ_{A} can include, but are not limited to, an imaging angle within the predetermined imaging angle range between zero degrees and sixty degrees. In selected embodiments, the first and second predetermined imaging angle Θ_{A} can be within a preselected imaging angle subrange of the predetermined imaging angle range, such as a preselected thirty degree subrange between zero degrees and thirty degrees. Although shown as comprising downwardly-inclined imaging angles in FIG. 6B for purposes of illustration only, the first predetermined imaging angle Θ_{A} and/or the second predetermined imaging angle Θ_{B} can comprise an upwardly-inclined imaging angle in selected embodiments.

Additionally and/or alternatively, the sensor calibration system 100 can be configured to perform stating sensor system calibration. The sensor calibration system 100, in other words, can support a robotic implementation of static sensor calibration for the sensor system 210 and/or the device under test 200 as shown in FIG. 7. Turning to FIG. 7, the sensor calibration system 100 is shown as including the turntable system 110 for supporting and/or rotating the device under test 200 and/or the sensor system 210 and the calibration target system 120 being disposed adjacent to the turntable system 110. The sensor calibration system 100 of FIG. 7 is shown as comprising a robotic arm 125. In selected embodiments, the robotic arm 125 can comprise an articulated robotic arm 125 with an end effector member 125C in the manner shown and described with reference to FIGS. 2A-B.

As shown in FIG. 7, the robotic arm 125 can extend the end effector member 125C up to a first elevation Y₁ above the positioning system base 128 and/or down to a second elevation Y₂ below the positioning system base 128. Exemplary first elevations Y₁ can include, but are not limited to, a predetermined first elevation within a predetermined first elevation range between zero meters and three meters; whereas, the second elevations Y₂ can include a predetermined second elevation within a predetermined second elevation range between zero meters and the predetermined height H_{c}(shown in FIG. 6A). In selected embodiments, the first elevation Y₁ can comprise a predetermined first elevation of 1.786 meters; whereas, the second elevation Y₂ can comprise a predetermined second elevation of 0.720 meters.

Additionally and/or alternatively, the robotic arm 125 can extend the end effector member 125C away from the turntable system 110 by a first distance X₁ and/or toward the turntable system 110 by a second distance X₂. Exemplary first distances X₁ can include, but are not limited to, a predetermined first distances within a predetermined first distance range between zero meters and three meters; whereas, the second distance X₂ can include a predetermined second distance within a predetermined second distance range between zero meters and three meters. In selected embodiments, the first distance X₁ can comprise a predetermined first distance of 1.150 meters; whereas, the second distance X₂ can comprise a predetermined second distance of 1.450 meters.

The robotic arm 125 optionally can have between two and nine degrees of freedom and/or an effective range radius that is between zero meters and a sum of the first and second distances X₁, X₂ and/or a sum of the first and second elevations Y₁, Y₂. Continuing with the above numerical example, the effective range radius of the robotic arm 125 can be between a half meter and three meters. A combined movement of the turntable system 110 and the robotic arm 125 advantageously can provide a hemispheric effect calibration reachable volume RV around the device under test 200 and/or the sensor system 210 as illustrated in FIG. 7.

The hemispheric effect calibration reachable volume RV with a predetermined diameter X_{RV}. The predetermined diameter X_{RV} can be equal to the sum of the first and second distances X₁, X₂ and/or the sum of the first and second elevations Y₁, Y₂ in selected embodiments. Based upon the above numerical example, the predetermined diameter X_{RV} of the calibration reachable volume RV provided by the combined movement of the turntable system 110 and the robotic arm 125 can include a predetermined diameter within a predetermined diameter range between six meters and twelve meters.

In the manner discussed in more detail above with reference to FIGS. 1 and 2A-B, the calibration target system 120 can be associated with one or more calibration target devices 122, wherein each calibration target device 122 can have calibration indicia 124 suitable for calibrating the device under test 200 and/or sensor system 210. The calibration indicia 124 of the calibration target devices 122 can differ, for example, based upon a type of device under test 200 and/or sensor system 210 being calibrated. A suitable calibration target device 122 thereby can be selected based upon the type of device under test 200 and/or sensor system 210 being calibrated and, as shown in FIGS. 8A-B, 9A-B and 10A-B, can be removably coupled with the end effector member 125C of the calibration target system 120 for calibrating the device under test 200 and/or the sensor system 210.

The selected calibration target device 122 preferably can be easily coupled with, and/or removed from, the end effector member 125C for facilitating rapid reconfiguration of the sensor calibration system 100 between extrinsic sensor calibration processes. The calibration target devices 122, for example, can be disposed within a reachable area of the robotic arm 125 for permitting the robotic arm 125 to retrieve the selected calibration target device 122 for use during a calibration process and to stow the selected calibration target device 122 after the calibration process is complete. The selected calibration target device 122 can include any predetermined number and/or type of calibration indicia 124 that is suitable for calibrating the relevant sensor system(s) 210 (shown in FIG. 1). The selected calibration target device 122, for example, can include one or more different calibration indicia 124 based upon the device under test 200 and/or the sensor system(s) 210 to be calibrated.

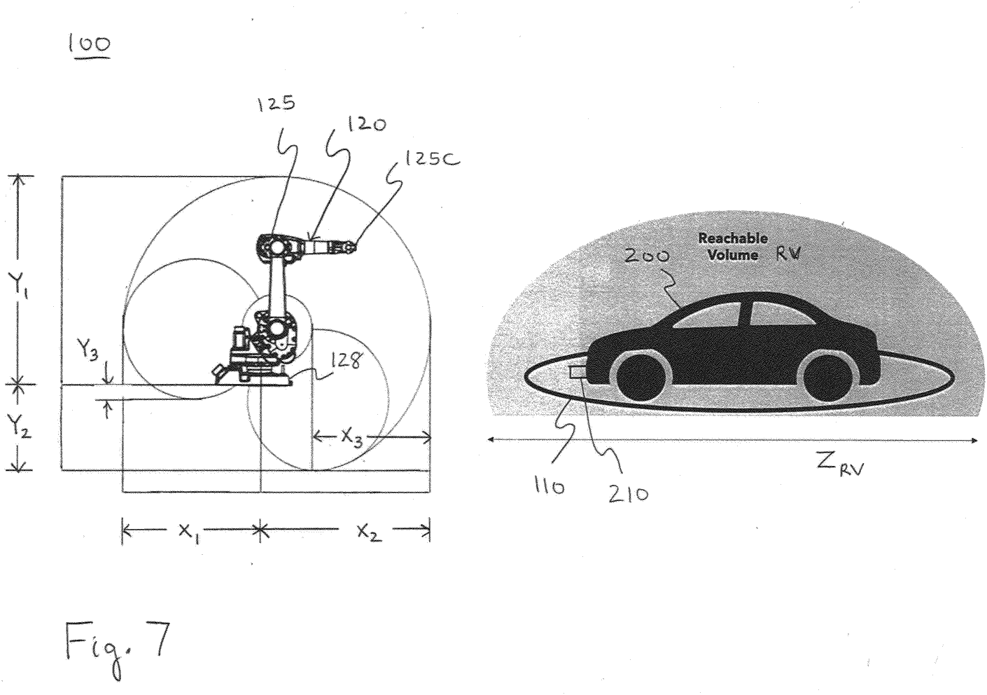

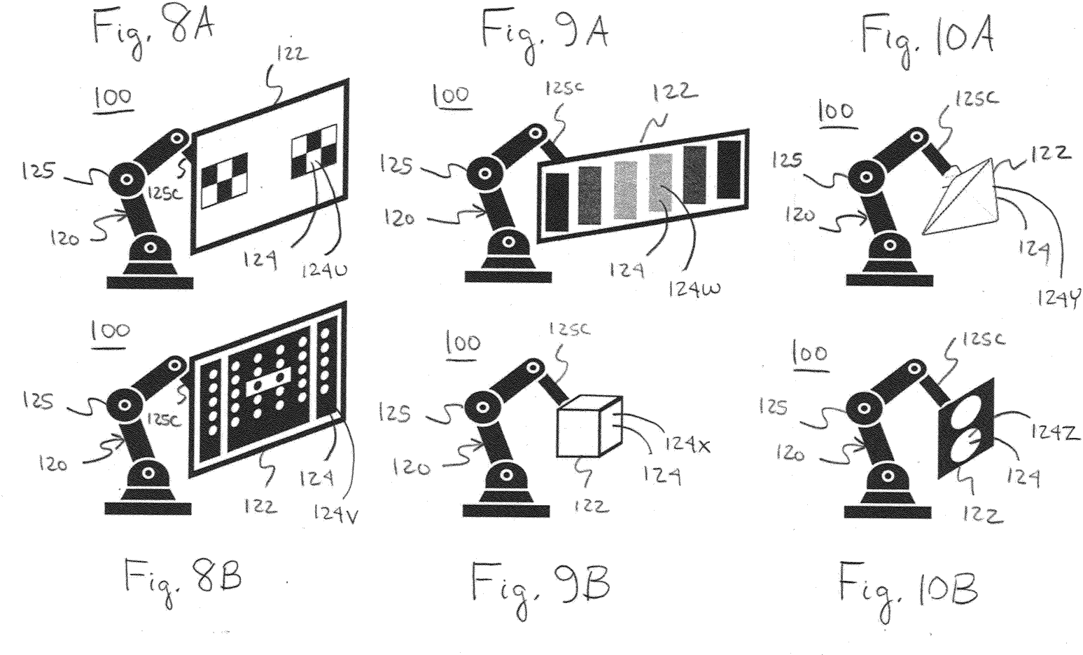

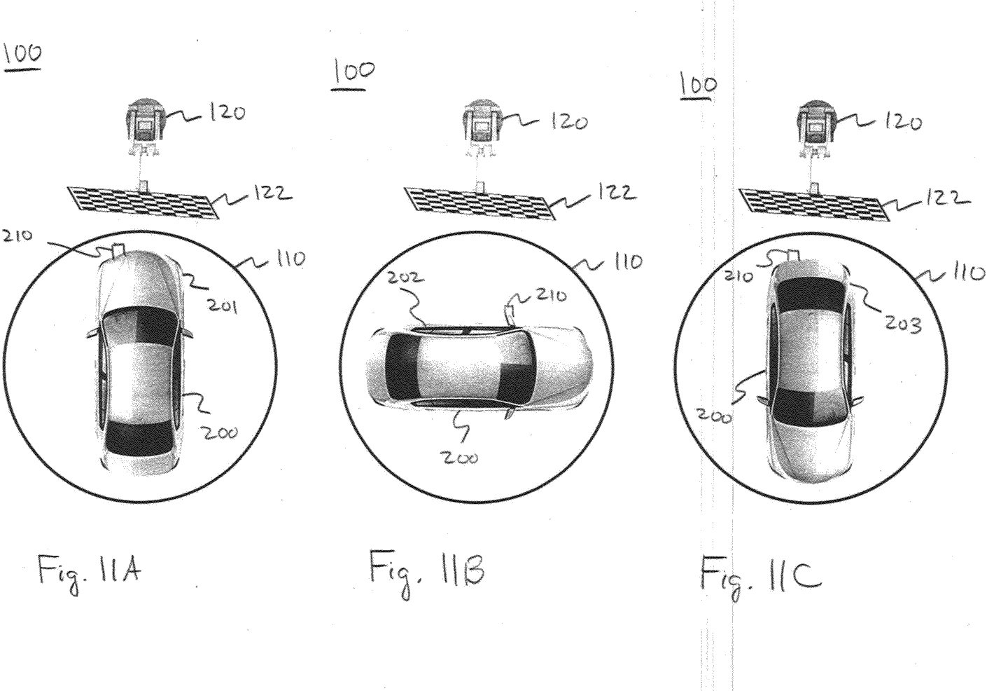

If the sensor system 210 comprises a camera imaging system, the selected calibration target device 122 can include first calibration indicia 124U suitable for calibrating the camera imaging system as shown in FIG. 8A. The selected calibration target device 122 alternatively can include second calibration indicia 124V for calibrating the camera imaging system as illustrated in FIG. 8B. The selected calibration target device 122 optionally can include third calibration indicia 124W suitable for calibrating a LiDAR imaging system as shown in FIG. 9A if the LiDAR imaging system is disposed aboard the device under test 200 (shown in FIG. 1) as the sensor system 210 (shown in FIG. 1). The selected calibration target device 122 alternatively can include second calibration indicia 124X for calibrating the LiDAR imaging system as illustrated in FIG. 9B. Additionally and/or alternatively, if the sensor system 210 (shown in FIG. 1) comprises a RADAR imaging system, the selected calibration target device 122 can include fifth calibration indicia 124Y suitable for calibrating the RADAR imaging system as shown in FIG. 10A. The selected calibration target device 122 alternatively can include sixth calibration indicia 124Z for calibrating the RADAR imaging system as illustrated in FIG. 10B.

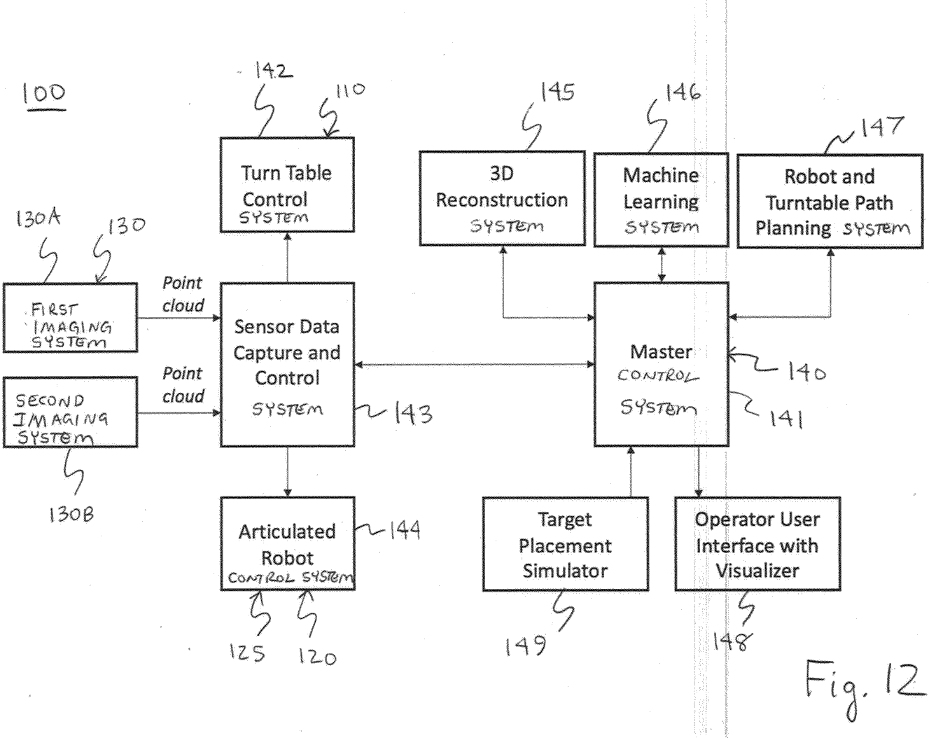

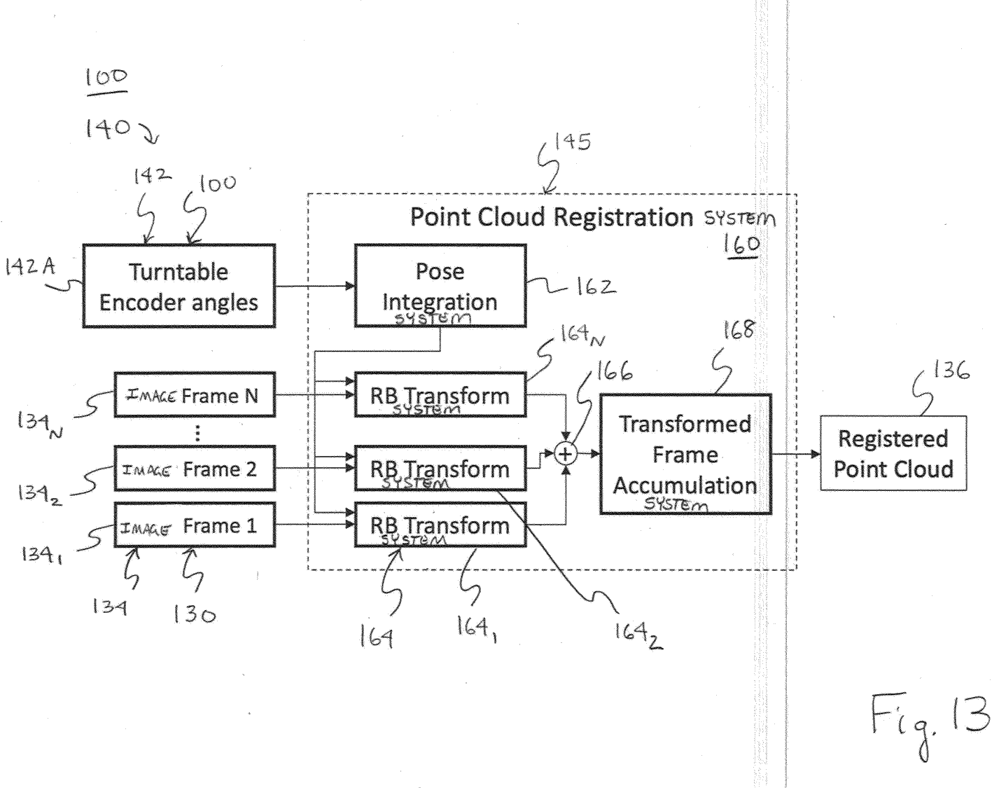

The sensor system 210 advantageously can be disposed at a suitable position relative to the selected calibration target device 122 of the calibration target system 120. In other words, a rotation or other movement of the turntable system 110 and/or the calibration target system 120 can be controlled such that the device under test 200 and/or the sensor system 210 is disposed at a suitable position within the calibration reachable volume RV (shown in FIG. 7) of the turntable system 110 and the calibration target system 120. If the sensor system 210 is disposed at a front region 201 of the device under test 200, the turntable system 110 can rotate the device under test 200 such that the front region 201 is adjacent to the calibration target system 120 as shown in FIG. 11A. The calibration target system 120 can adjust a position of the selected calibration target device 122 relative to the front region 201 of the device under test 200 and/or the sensor system 210. The sensor calibration system 100 disposed at the front region 201 thereby can be disposed at a suitable position relative to the selected calibration target device 122 for enabling the sensor calibration system 100 to proceed with the calibration process.

FIG. 11B shows that the turntable system 110 can rotate the device under test 200 such that a side region 202 is adjacent to the calibration target system 120 if the sensor system 210 is disposed at the side region 202 of the device under test 200. The calibration target system 120 can adjust a position of the selected calibration target device 122, as needed, relative to the side region 202 of the device under test 200 and/or the sensor system 210. The sensor calibration system 100 disposed at the side region 202 thereby can be disposed at a suitable position relative to the selected calibration target device 122 for enabling the sensor calibration system 100 to proceed with the calibration process.

If the sensor system 210 is disposed at a back (or rear) region 203 of the device under test 200 as illustrated in FIG. 11C, the turntable system 110 can rotate the device under test 200 such that the rear region 203 is adjacent to the calibration target system 120. The calibration target system 120 can adjust a position of the selected calibration target device 122 relative to the rear region 203 of the device under test 200 and/or the sensor system 210. The sensor calibration system 100 disposed at the rear region 203 thereby can be disposed at a suitable position relative to the selected calibration target device 122 for enabling the sensor calibration system 100 to proceed with the calibration process. In other words, the device under test 200 and/or the sensor system 210 can be disposed at a proper orientation relative to the selected calibration target device 122 regardless of a location of the sensor system 210 within the device under test 200 by controlling a positioning or other movement of the turntable system 110 and/or the calibration target system 120.

An exemplary control system 140 for the sensor calibration system 100 is shown in FIG. 12. Turning to FIG. 12, the control system 140 is shown as including a sensor data capture and control system (or circuit) 143 that can communicate with a master control system (or circuit) 141. The sensor data capture and control system 143 can receive point cloud image and other sensor data from each imaging system 130. As shown in FIG. 12, the sensor data capture and control system 143 can receive first point cloud image and other sensor data from the first imaging system 130A and/or second point cloud image and other sensor data from the second imaging system 130B. The point cloud image and other sensor data received from the imaging systems 130 optionally can comprise synchronized point cloud image and other sensor data. The sensor data capture and control system 143 can provide one or more imaging control commands to the imaging control system (not shown) for controlling the positioning and/or operation of the respective imaging systems 130.

Additionally and/or alternatively, the sensor data capture and control system 143 can communicate with the turntable control system 142 for controlling the positioning and/or operation of the turntable system 110 and/or the calibration target control system 144 for controlling the positioning and/or operation of the calibration target system 120. The sensor data capture and control system 143, for example, can provide one or more turntable control commands to the turntable control system 142 for controlling the orientation of the turntable system 110. Similarly, the sensor data capture and control system 143 can provide one or more target control commands to the calibration target control system 144 for controlling the orientation and other positioning of the calibration target system 120.

The sensor data capture and control system 143, for example, can provide one or more turntable control commands to the turntable control system 142 for controlling the orientation of the turntable system 110. If the calibration target system 120 comprises the robotic arm 125 with the end effector member 125C for coupling with the selected calibration target device 122 (shown in FIG. 3), the sensor data capture and control system 143 can provide a target control command to the calibration target control system 144 for commanding the robotic arm 125 to couple a selected calibration target device 122 to the end effector member 125C and/or to move the end effector member 125C to a predetermined position and/or orientation.

In selected embodiments, communication between the sensor data capture and control system 143 and the turntable control system 142 and/or the calibration target control system 144 can comprises bidirectional communication. The sensor data capture and control system 143 thereby can receive turntable feedback data from the turntable control system 142 and/or target feedback data from the calibration target control system 144. Exemplary turntable feedback data can include, but is not limited to, a current orientation and/or rotational speed of the turntable control system 142; whereas, the target feedback data can comprise data with regard to whether a calibration target device 122 is currently coupled with the end effector member 125C, identity information about any currently-coupled calibration target device 122 and/or a current position and/or orientation of the end effector member 125C. Advantageously, the sensor data capture and control system 143 can utilize the received turntable feedback data to control the turntable system 110. The sensor data capture and control system 143 likewise can utilize the received target feedback data to control the calibration target system 120.

The sensor data capture and control system 143 is illustrated in FIG. 12 as supporting bidirectional communication for exchanging data and commands with the master control system 141. The master control system 141 can communicate with one or more other subsystems of the control system 140. As shown in FIG. 12, for example, the master control system 141 can communicate with a three-dimension reconstruction system (or circuit) 145 for reconstructing the registered point cloud image 136 (shown in FIG. 13) of the device under test 200 disposed on the turntable system 110 in the manner set forth above with reference to FIG. 5A. The three-dimension reconstruction system 145 advantageously can receive multiple measurements of the device under test 200 from different vantage points and can convert the received measurements into the registered point cloud image 136.

FIG. 13 shows an exemplary three-dimension reconstruction system 145 of the control system 140. Turning to FIG. 13, the three-dimension reconstruction system 145 is illustrated as comprising a point cloud registration system (or circuit) 160 for receiving turntable encoder angle data from the turntable system 110 (shown in FIG. 1) and image frame data 134 from at least one imaging system 130 (shown in FIG. 1). The image frame data 134 can comprise a sequence or other plurality of image frames 134₁, 134₂, ..., 134_{N}.

As the turntable system 110 with the device under test 200 rotates, the high-precision controller and encoder system 142A of the turntable control system 142 can record a sequence or other plurality of encoder angles of the turntable system 110 in the manner discussed above with reference to FIGS. 1 and 3. The high-precision controller and encoder system 142A can provide the recorded encoder angles to the point cloud registration system 160. In selected embodiments, the high-precision controller and encoder system 142A can provide the recorded encoder angles to the point cloud registration system 160 via the sensor data capture and control system 143 (shown in FIG. 12) and/or the master control system 141 (shown in FIG. 12). The point cloud registration system 160 can receive the recorded encoder angles via a pose integration system (or circuit) 162. In selected embodiments, the pose integration system 162 can comprise a rigid body pose integration system.

The imaging system 130 likewise can capture the image frame data 134 of the rotating device under test 200 at the turntable system 110. Stated somewhat differently, the image frame data 134 can comprise a plurality of images of the device under test 200 captured by the imaging system 130 at respective different angles as the device under test 200 via the turntable system 110. The imaging system 130 and/or the imaging control system associated with the imaging system 130 can provide the captured image frame data 134 to the point cloud registration system 160. In selected embodiments, the imaging system 130 and/or the imaging control system can provide the captured image frame data 134 to the point cloud registration system 160 via the sensor data capture and control system 143 and/or the master control system 141. The point cloud registration system 160 can receive the captured image frame data 134 via a rigid body (or RB) transform system (or circuit) 164.

As illustrated in FIG. 13, the rigid body transform system 164 can comprise a plurality of rigid body transform subsystems 164₁, 164₂, ..., 164_{N} for receiving a respective one of the image frames 134₁, 134₂, ..., 134_{N}. The rigid body transform system 164 can integrate the recorded encoder angles from the pose integration system 162 with the captured image frame data 134 to produce a rigid body transform of the captured image frame data 134 for explaining the rotation or other motion of the turntable system 100. More specifically, the first rigid body transform subsystem 164₁ can integrate a first recorded encoder angle from the pose integration system 162 with the first captured image frame data 134₁ to produce a first rigid body transform of the captured image frame data 134. The second rigid body transform subsystem 164₂ can integrate a second recorded encoder angle from the pose integration system 162 with the second captured image frame data 134₂ to produce a second rigid body transform of the captured image frame data 134 and so on until the Nth rigid body transform subsystem 164_{N} integrates an Nth recorded encoder angle from the pose integration system 162 with the Nth captured image frame data 134_{N} to produce a Nth rigid body transform of the captured image frame data 134.

The rigid body transforms of the image frames 134₁, 134₂, ..., 134_{N} can be combined, at 166, and a transformed frame accumulation system (or circuit) 168 advantageously can transform and/or accumulate the combined rigid body transforms the image frames 134₁, 134₂, ..., 134_{N} into a preselected coordinate system. The transformed frame accumulation system 168 thereby can generate the three-dimensional registered point cloud image 136 of the device under test 200 in the preselected coordinate system. Stated somewhat differently, the three-dimensional registered point cloud image 136 can comprise a dense point cloud image of the device under test 200 in a chosen coordinate frame of reference. Any noisy points in the three-dimensional registered point cloud image 136 of the device under test 200 optionally can be filtered.

Returning briefly to FIG. 12, the master control system 141 optionally can communicate with a machine learning system (or circuit) 146 for deciphering one or more aspects and/or segments of the device under test 200 disposed on the turntable system 110. The machine learning system 146 can extract one or more device parts, features, markers or other device components 220 of the device under test 200 as illustrated in FIG. 14. If the device under test 200 comprises a passenger vehicle as shown in FIG. 14, exemplary device components 220 of the passenger vehicle can include, but are not limited to, at least one vehicle mirror 222, at least one vehicle bumper 224, at least one vehicle wheel 226 (or a center of the vehicle wheel 226), at least one vehicle thrust line, at least one vehicle door and/or at least one vehicle pillar. The machine learning system 146 of FIG. 14 is shown as extracting left and right sideview mirrors 222L, 222R, front and rear bumpers 224F, 224R and/or centers of left front, right front and right rear wheels 226LF, 226RF, 226RR.

The machine learning system 146 can extract the device components 220 of the device under test 200 in any suitable matter. As illustrated in FIG. 14, for example, the machine learning system 146 can extract the device components 220 based upon the three-dimensional registered point cloud image 136 of the device under test 200. In selected embodiments, the machine learning system 146 can comprise a neural network-based machine learning framework (not shown) that previously has been trained on data for a plurality of passenger vehicles and other types of devices under test 200. The training data can include one or more component labels that are associated with respective device components 220 for each of the passenger vehicles and other types of devices under test 200. Stated somewhat differently, each device under test 200 in the training data can include at least one device component 220 that has been associated with a respective label.

The neural network-based machine learning framework enable a neural network inference to be run on the three-dimensional registered point cloud image 136 of the passenger vehicle. Based upon the neural network inference, the neural network-based machine learning framework can compare the three-dimensional registered point cloud image 136 with the labelled training data. The neural network-based machine learning framework, in other words, can identify a known passenger vehicle having a collection of labelled device components 220 within the labelled data that best matches the extracted device components 220 of the passenger vehicle depicted by the three-dimensional registered point cloud image 136. Thereby, the neural network-based machine learning framework can identify and localize one or more device components 220 of the passenger vehicle within the three-dimensional registered point cloud image 136.

Returning again to FIG. 12, the master control system 141 optionally can communicate with a robot and turntable path planning system 147 for solving forward and inverse kinematics of the turntable system 110 and the calibration target system 120. The robot and turntable path planning system 147 advantageously can control a movement of the turntable system 100 and the calibration target system 120 into desired orientations and/or positions while avoiding any collision with the device under test 200 at the turntable system 110 or any other object in a sensor calibration environment in which the sensor calibration system 100 is disposed. Stated somewhat differently, the robot and turntable path planning system 147 can avoid a movement path of the calibration target system 120 that could lead to a collision between the selected calibration target device 122 (shown in FIG. 3) or the calibration target positioning system 126 (shown in FIG. 3) and the device under test 200 as oriented on the turntable system 110 or any other object in the sensor calibration environment.

The master control system 141 is illustrated as communicating with the user interface 148 for enabling the system operator or other system user (not shown) to interact with the sensor calibration system 100. The master control system 141, for example, can enable the system user to provide instruction to the sensor calibration system 100. Exemplary instructions can include, but are not limited to, instruction for configuring the sensor calibration system 100 to perform an extrinsic sensor calibration process for the device under test 200 (shown in FIG. 1) and/or the sensor system 210 (shown in FIG. 1), instruction for initiating the extrinsic sensor calibration process and/or instruction for terminating the extrinsic sensor calibration process. The instruction for configuring the sensor calibration system 100 can comprise instruction for selecting the selected calibration target device 122 (shown in FIG. 3) for disposal on the calibration target positioning system 126 (shown in FIG. 3) and/or instruction for coupling the selected calibration target device 122 with the calibration target positioning system 126, without limitation. In selected embodiments, the user interface 148 can visually and/or audibly present one or more results of the extrinsic sensor calibration process. The user interface 148 optionally can present diagnostic information associated with the extrinsic sensor calibration process.

As shown in FIG. 12, the master control system 141 optionally can communicate with a target placement simulator system (or circuit) 149. The target placement simulator system 149 advantageously can aid in designing extrinsic sensor calibration process procedures for specific types of devices under test 200 and/or sensor systems 210. For example, the target placement simulator system 149 can provide at least one tool 149A for disposing one or more virtual calibration target devices 122V around a virtual device under test 200V that is associated with a virtual sensor system 210V as illustrated in FIG. 15. The virtual device under test 200V and/or virtual sensor system 210V can be very similar to an actual (or physical) device under test 200 (shown in FIG. 1) and/or sensor system 210 (shown in FIG. 1) intended for undergoing an extrinsic sensor calibration process. In other words, the virtual device under test 200V can comprise a model of the actual device under test 200; whereas, the virtual sensor system 210V can comprise a model of the actual sensor system 210 intended for undergoing an extrinsic sensor calibration process.

The target placement simulator system 149 advantageously can present or otherwise provide a virtual sensor calibration environment for the actual device under test 200 and/or sensor system 210. The tool 149A advantageously can enable the system user to design the virtual sensor calibration environment by establishing and/or adjusting a number, selection, position and/or orientation of the virtual calibration target devices 122V. As desired, the sensor calibration system 100 can precisely replicate the virtual sensor calibration environment via the actual turntable system 110 (shown in FIG. 1) and one or more calibration target systems 120 (shown in FIG. 1) for performing the extrinsic sensor calibration process on the actual device under test 200 and/or sensor system 210 in the actual sensor calibration environment.

Stated somewhat differently, the number, selection, position and/or orientation of the virtual calibration target devices 122V can be transferred to the calibration target systems 120. In selected embodiments, the robot and turntable path planning system 147 (shown in FIG. 12) can control a movement of the turntable system 100 and/or the calibration target system 120 into the desired orientations and/or positions in the manner discussed in more detail above with reference to FIG. 12. The tool 149A optionally can comprise a computer-implemented tool that is presented or otherwise provided via a processing system (or circuit) 149B, such as a computer server system, a personal computing system, laptop computing system, tablet computing system, mobile telephone system or any other conventional type of suitable processing system.

Although shown and described with reference to FIG. 12 as comprising separate systems for purposes of illustration only, one or more of the master control system 141, the turntable control system 142, sensor data capture and control system 143, the calibration target control system 144, the imaging control system, the three-dimension reconstruction system 145, the machine learning system 146, the robot and turntable path planning system 147, the user interface 148 and/or the target placement simulator system 149 can be completely or at least partially integrated into a composite system, as desired.

Although selected embodiments of the sensor calibration system 100 and/or the extrinsic calibration method 300 have been set forth herein with reference to certain numerical values and/or numerical value ranges, it will be appreciated that the numerical values are provided for purposes of illustration only and not for purposes of limitation. The numerical values and/or numerical value ranges that are associated with selected features of the sensor calibration system 100 and/or the extrinsic calibration method 300 can depend upon a particular application of the sensor calibration system 100 and/or the extrinsic calibration method 300, such as by being based upon the weight, size, diameter, shape and/or other characteristic of the device(s) under test 200 to be accommodated. It also will be appreciated that the numerical values and/or numerical value ranges in some cases can be outside of the recited predetermined ranges and/or inside of the preselected subranges within the predetermined ranges.

In selected embodiments, one or more of the features disclosed herein can be provided as a computer program product being encoded on one or more non-transitory machine-readable storage media. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

What is claimed is:

1. A method for automatically calibrating a sensor system associated with a device under test, comprising:
scanning the device under test to identify the device under test;
configuring a calibration target system for cooperating with the identified device under test; and
calibrating the sensor system via the configured calibration target system.

2. The method of claim 1, wherein said scanning the device under test includes:
capturing a three-dimensional image of the device under test; and
identifying the device under test based upon the captured three-dimensional image.

3. The method of claim 2, wherein said capturing the three-dimensional image comprises:
rotating the device under test relative to an imaging circuit; and
capturing a three-dimensional registered point cloud image of the rotated device under test via the imaging circuit.

4. The method of claim 3, wherein said capturing the three-dimensional registered point cloud image comprises:
recording a plurality of encoder angles from a turntable system for rotating the device under test;
capturing a sequence of image frames of the rotating device under test;
generating a plurality of rigid body transforms from the captured image frames and the respective recorded encoder angles; and
combining the generated rigid body transforms into a preselected coordinate system to provide the three-dimensional registered point cloud image.

5. The method of claim 2, wherein said identifying the device under test comprises:
extracting at least one device marker from the captured three-dimensional image; and
identifying the device under test based upon the extracted device marker.

6. The method of claim 5, wherein said extracting the at least one device marker includes extracting a device mirror, a device bumper, a device wheel, a center of the device wheel, a center of device axle, a device logo, a device thrust line, a device door, a device pillar from the captured three-dimensional image.

7. The method of claim 5, wherein said extracting the at least one device marker comprises:
training a machine learning framework with device data for a plurality of different types of devices under test; and
extracting the at least one device marker from the captured three-dimensional image via the trained machine learning framework.

8. The method of claim 2, wherein said identifying the device under test includes identifying the sensor system based upon the captured three-dimensional image.

9. The method of claim 1, wherein said configuring the calibration target system includes:
selecting a calibration target device with calibration indicia suitable for calibrating the sensor system of the identified device under test;
disposing the selected calibration target device on a calibration target positioning system of the calibration target system; and
establishing at least one position attribute of the selected calibration target device relative to the sensor system via the calibration target positioning system.

10. The method of claim 9, wherein said selecting the calibration target device comprises selecting the calibration target device from a plurality of calibration target devices with different calibration indicia.

11. The method of claim 9, wherein said establishing the at least one position attribute of the selected calibration target device includes translating in a radial direction and rotating in three dimensions the calibration target positioning system relative to the device under test.

12. The method of claim 9, wherein said configuring the calibration target system includes determining a travel path for transitioning the calibration target system into the at least one established position attribute while avoiding a collision between the selected calibration target device and the device under test.

13. The method of claim 12, wherein said determining the travel path comprises solving forward and inverse kinematics of the calibration target system and a turntable system for rotating the device under test.

14. The method of claim 1, wherein said configuring the calibration target system includes:
creating a virtual sensor calibration environment by disposing a virtual calibration target device adjacent to a virtual device under test via a processing circuit, the virtual device under test being associated with a virtual sensor system and comprising a model of the device under test;
simulating an extrinsic calibration process for the virtual sensor system via the created virtual sensor calibration environment;
adjusting at least one three dimensional position attribute of the virtual calibration target device via the processing circuit based upon said simulating the extrinsic calibration process; and
configuring the calibration target system by disposing a calibration target device associated with the calibration target system relative to the device under test in accordance with the at least one adjusted three dimensional position attribute of the virtual calibration target device.

15. The method of claim 1, wherein said calibrating the sensor system comprises calibrating an Advanced Driver Assistance (ADAS) sensor system or an Autonomous Vehicle (AV) sensor system disposed on a vehicle via the configured calibration target system.

16. A computer program product for automatically calibrating a sensor system associated with a device under test, the computer program product being encoded on one or more non-transitory machine-readable storage media and comprising:
instruction for scanning the device under test to identify the device under test;
instruction for configuring a robotic calibration target system for cooperating with the identified device under test; and
instruction for calibrating the sensor system via the configured calibration target system.

17. A system for automatically calibrating a sensor system associated with a device under test, comprising:
a central turntable system for rotating the device under test;
an articulated robotic calibration target system having an end effector member for coupling with a calibration target device;
first and second imaging circuits being configured for scanning the device under test to generate a three-dimensional image of the device under test as rotated by said turntable system, said first and second imaging circuits and said robotic calibration target system being disposed around a periphery of said turntable system; and
a control circuit for identifying the device under test based upon the three-dimensional image and configuring said robotic calibration target system for cooperating with the identified device under test,
wherein the sensor system is calibrated via said configured calibration target system.

18. The system of claim 17, wherein said articulated robotic calibration target system has between three and nine degrees of freedom and includes at least one rotational joint member, at least one prismatic joint member or both.

19. The system of claim 17, wherein each of said first and second imaging circuits is selected from an imaging circuit group consisting of a camera imaging circuit, a Light Detection and Ranging (LiDAR) imaging circuit, a Radio Detection and Ranging (RADAR) imaging circuit and an ultrasonic imaging circuit.

20. The system of claim 17, wherein said first imaging circuit and said robotic calibration target system are disposed in a first plane that passes through a central region of said turntable system, and wherein said second imaging system is disposed in a second plane that is normal to the first plane and that passes through the central region of said turntable system.
